(19) United States
(12) Patent Application Publication
(10) Pub. No.: US 2025/0048953 A1
(43) Pub. Date: Feb. 13, 2025

(54) SEMI-MOUNTED AGRICULTURAL IMPLEMENT WITH FORWARD LIFT-ASSIST AND RELATED AGRICULTURAL SYSTEM

(71) Applicant: CNH Industrial America LLC, New Holland, PA (US)

(72) Inventors: Austin Joseph Lewandowski, Congerville, IL (US); William E. Preller, Congerville, IL (US); Brian Michael Craig, Congerville, IL (US); Jeffry Scott Huber, Eureka, IL (US)

(21) Appl. No.: 18/798,649

(22) Filed: Aug. 8, 2024

Related U.S. Application Data
(60) Provisional application No. 63/518,935, filed on Aug. 11, 2023.

(51) Int. Cl. A01B 73/04

(52) U.S. Cl. CPC A01B 73/044

(57) ABSTRACT

An agricultural implement extends in a fore-aft direction between a forward end and an aft end. The agricultural implement includes a toolbar assembly comprising a central toolbar section and first and second wing toolbar sections pivotably coupled to the central toolbar section, with the central toolbar section configured to be mounted to a work vehicle via a semi-mounted configuration. Additionally, the implement includes first and second lift-assist assemblies pivotably coupled to the central toolbar section and extending outwardly therefrom in a forward direction of travel of the implement such that the lift-assist assemblies are positioned at forward end of the agricultural implement.

### CROSS-REFERENCE TO RELATED APPLICATIONS

The present application is based upon and claims the right of priority to U.S. Provisional Patent Application No. 63/518,935, filed Aug. 11, 2023, the disclosure of which is hereby incorporated by reference herein in its entirety for all purposes.

### FIELD OF THE INVENTION

The present subject matter relates generally to agricultural implements, such as strip-tillage implements and, more particularly, to a semi-mounted agricultural implement with forward lift-assist and a related agricultural system.

### BACKGROUND OF THE INVENTION

Due to market requirements within the agricultural industry, the size of agricultural implements has grown significantly over the years. For example, based on market demands, wider agricultural implements were developed that could cover larger swaths of the field with each pass, thereby increasing efficiency and reducing operating time. These implements typically incorporate wings or folding sections that allow the implement to be folded into a suitable transport position that meets certain width requirements for road transport. However, as the size of agricultural implements has been increased, so has the overall weight of such implements.

For mounted implements (e.g., three-point mounted implement), the lift capacity for the tractor's hydraulic system serves as a constraint on the overall amount of implement weight that can be supported by the tractor. In this regard, to allow heavier implements to be accommodated by a given tractor, semi-mounted implement configurations have been developed that include rearwardly positioned lift-assist assemblies that help support the weight of the implement. While such rear-mounted lift-assist assemblies have proven advantageous in numerous applications, alternative solutions are needed for providing different lift-assist configurations for semi-mounted implements to accommodate new and/or varying market requirements.

Accordingly, a semi-mounted agricultural implement having an alternative lift-assist configuration would be welcomed in the technology.

### BRIEF DESCRIPTION OF THE INVENTION

Aspects and advantages of the invention will be set forth in part in the following description, or may be obvious from the description, or may be learned through practice of the invention.

In one aspect, the present subject matter is directed to an agricultural implement extending in a fore-aft direction between a forward end and an aft end. The agricultural implement includes a toolbar assembly comprising a central toolbar section and first and second wing toolbar sections pivotably coupled to the central toolbar section, with the central toolbar section configured to be mounted to a work vehicle via a semi-mounted configuration. Additionally, the implement includes first and second lift-assist assemblies pivotably coupled to the central toolbar section and extending outwardly therefrom in a forward direction of travel of the implement such that the lift-assist assemblies are positioned at forward end of the agricultural implement.

In another aspect, the present subject matter is directed to an agricultural system including a work vehicle having first and second rear traction elements and an agricultural implement configured to be towed by the work vehicle. The agricultural implement includes a toolbar assembly having a central toolbar section and first and second wing toolbar sections pivotably coupled to the central toolbar section, with the central toolbar section configured to be mounted to the work vehicle via a semi-mounted configuration. The implement also includes first and second lift-assist assemblies pivotably coupled to the central toolbar section and extending outwardly therefrom in a forward direction of travel of the agricultural implement such that the lift-assist assemblies are at least partially aligned with the first and second rear traction elements of the work vehicle in a lateral direction of the agricultural implement.

In further aspect, the present subject matter is directed to an agricultural implement extending in a fore-aft direction between a forward end and an aft end. The agricultural implement includes a toolbar assembly comprising a central toolbar section and first and second wing toolbar sections pivotably coupled to the central toolbar section. The implement also includes first and second lift-assist assemblies pivotably coupled to the central toolbar section and extending outwardly therefrom in a forward direction of travel of the implement such that the lift-assist assemblies are positioned at forward end of the agricultural implement. In addition, the implement includes an articulating chassis assembly coupled to the toolbar assembly and being disposed in a trailing position relative to the toolbar assembly such that the chassis assembly is positioned at the aft end of the agricultural implement.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a perspective view of one embodiment of an agricultural implement in accordance with aspects of the present subject matter, particularly illustrating the implement in a semi-mounted configuration relative to an aft portion of a work vehicle (e.g., a tractor) and with the implement supporting a storage tank along an aft end thereof;

FIG. 2 illustrates a top view of the implement and aft portion of the work vehicle shown in FIG. 1;

FIG. 3 illustrates a perspective view of the implement shown in FIG. 1 with the aft portion of the work vehicle and storage tank removed for purposes of illustration;

FIG. 4 illustrates a zoomed-in, perspective view of a forward portion of the implement shown in FIG. 2, particularly illustrating a toolbar assembly implement having front-mounted lift-assist assemblies associated therewith;

FIG. 5 illustrates a zoomed-in, perspective view of a central toolbar section of the toolbar assembly shown in FIG. 4, particularly illustrating the lift-assist assemblies coupled to opposed lateral ends of the central toolbar section;

FIG. 6 illustrates a zoomed-in, perspective view of a wing toolbar section of the toolbar assembly shown in FIG. 4;

FIG. 7 illustrates a zoomed-in perspective view of an articulation joint provided in association with a rear-mounted chassis assembly of the implement shown in FIG. 3;

FIG. 8 illustrates another perspective view of the implement shown in FIG. 3, particularly illustrating the rear chassis assembly pivoted relative to the remainder of the implement about the articulation joint;

FIG. 9 illustrates a perspective view of the implement shown in FIG. 3 (with the storage tank added) after it has transitioned from its working position to its transport position;

FIG. 10 illustrates a perspective view of the implement and aft portion of the work vehicle shown in FIG. 1 after the implement has transitioned from its working position to its transport position; and

FIG. 11 illustrates a top view of the implement and aft portion of the work vehicle shown in FIG. 10.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to a semi-mounted agricultural implement with forward lift-assist. Specifically, in several embodiments, the implement may include a pair of forward-mounted lift-assist assemblies extending outwardly from a toolbar assembly of the implement in the forward direction. As will be described below, in one embodiment, the lift-assist assemblies extend from the toolbar assembly in the forward direction such that the lift-assist assemblies are at least partially aligned with adjacent traction elements of the associated work vehicle (e.g., the rear tires or rear tracks of the tractor configured to tow the implement).

Additionally, in several embodiments, the semi-mounted implement may include an articulating rear chassis assembly positioned aft of the toolbar assembly. In such an embodiment, the implement may include lift-assist assemblies positioned at its forward end and the articulating rear chassis assembly positioned at its aft end, with the toolbar assembly being positioned between the lift-assist assembly and chassis assembly in the fore-aft direction of the implement. The rear-mounted chassis assembly may be configured to support one or more storage tanks for storing agricultural materials (e.g., fertilizer and/or the like).

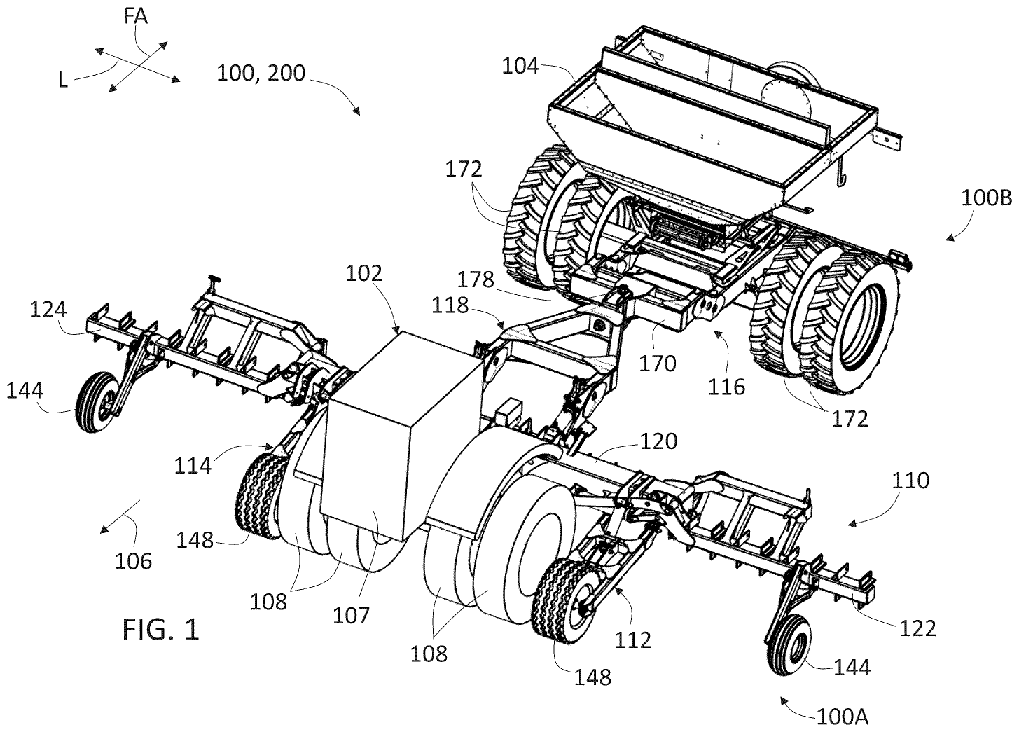

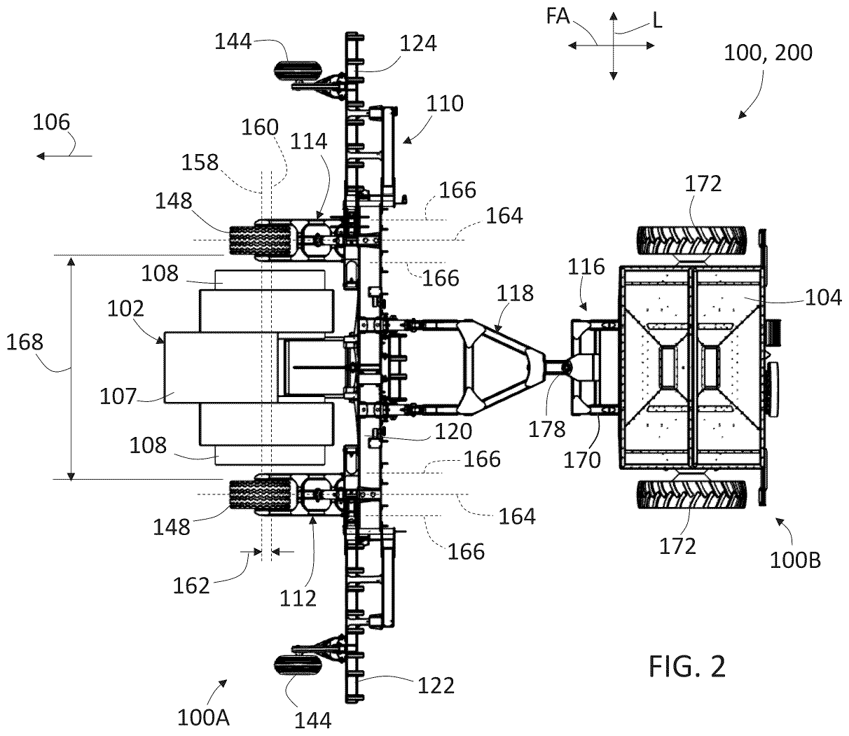

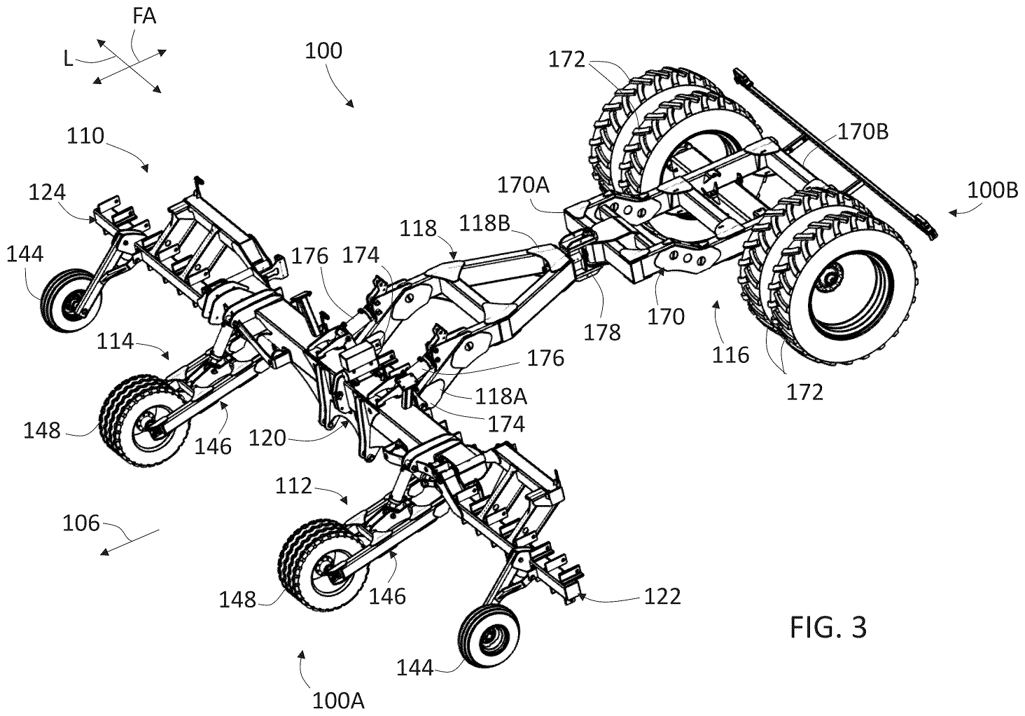

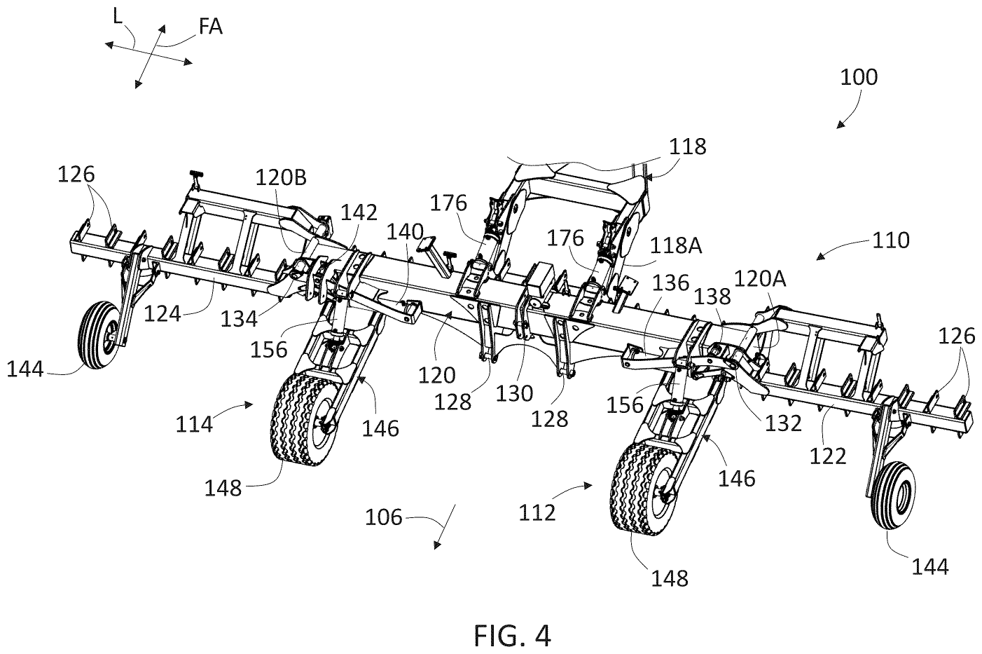

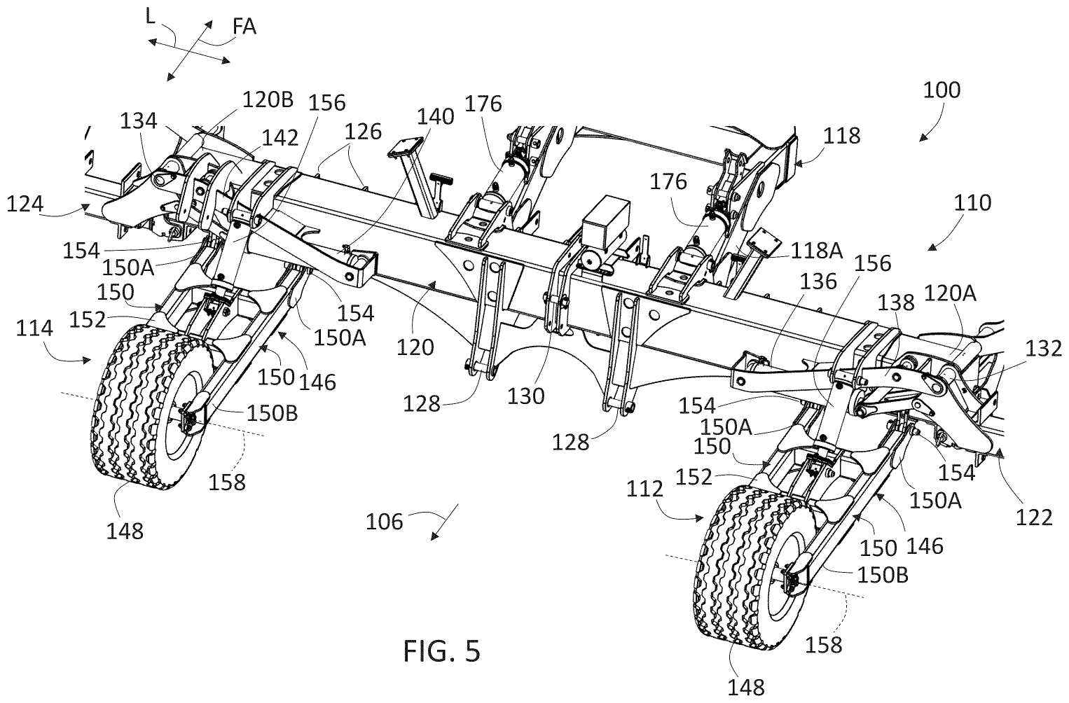

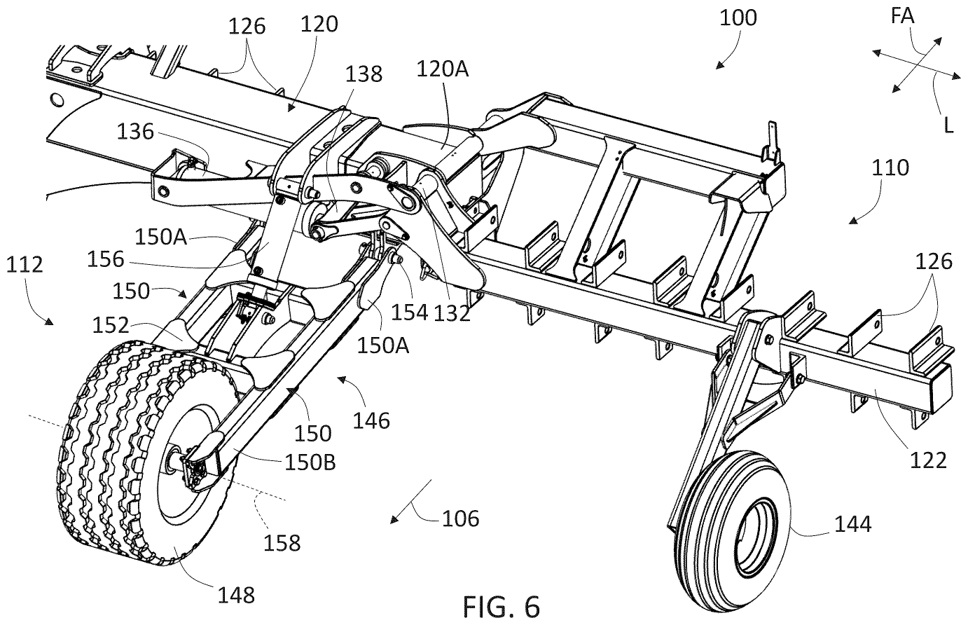

Referring now to the drawings, FIGS. 1-6 illustrate several views of one embodiment of an agricultural implement 100 and related agricultural system 200 in accordance with aspects of the present subject matter. Specifically, FIGS. 1 and 2 illustrate perspective and top views, respectively, of the agricultural implement 100 as mounted to an aft portion of a work vehicle 102 (e.g., an aft portion of a tractor including its rear traction elements and a rear section of its cab), while FIGS. 3-6 illustrate numerous other views of the implement 100 with the aft portion of the work vehicle 102 and an implement-based storage tank 104 removed therefrom for purposes of illustration. For example, FIG. 3 illustrates a front perspective view of the implement 100 with the aft portion of the work vehicle 102 and the storage tank 104 removed for purposes of illustration. Additionally, FIG. 4 illustrates a front perspective view of a forward portion of the implement 100 shown in FIG. 3 including a toolbar assembly and forward-mounted lift-assist assemblies of the implement 100, with FIG. 5 illustrating a zoomed-in view of a central toolbar section of the toolbar assembly and the associated front lift-assist assemblies shown in FIG. 4 and FIG. 6 illustrating a zoomed-in view of a wing toolbar section of the toolbar assembly and one of the lift-assist assemblies shown in FIG. 4.

In general, the implement 100 may be configured to be towed across a field in a forward direction of travel (e.g., as indicated by arrow 106 in FIGS. 1-6) by a work vehicle 102 (e.g., an agricultural tractor). As shown, the implement 100 is configured as a strip tillage implement. However, in other embodiments, the implement 100 may be configured as any other suitable type of implement, such as a conventional tillage implement, seed-planting implement, a fertilizer-dispensing implement, and/or the like. It should be appreciated that, for purposes of illustration, only an aft portion of the work vehicle 102 is shown in FIGS. 1 and 2 to allow the positional relationship between the implement 100 and such portion of the vehicle 102 to be shown. Specifically, FIGS. 1 and 2 schematically illustrate a rear portion of an operator's cab of the work vehicle (indicated by the rectangular box 107) and the rear traction elements 108 of the work vehicle 102. In the illustrated embodiment, the work vehicle 102 is a wheeled vehicle and, thus, the rear traction elements 108 correspond to rear wheels. However, in other embodiments, the work vehicle 102 may be configured as a tracked vehicle, in which case the rear traction elements 108 may correspond to track assemblies. It should be appreciated that the disclosed implement 100 and work vehicle 102 may generally be considered as components of an agricultural system 200 (FIGS. 1 and 2) in accordance with aspects of the present subject matter.

As shown in FIGS. 1-3, the implement 100 generally extends in a fore-aft direction (indicated by arrow FA) between a forward end 100A and an aft end 100B and includes a toolbar assembly 110 positioned between the forward and aft ends 100A, 100B of the implement 100. In addition, the implement 100 includes a pair of forward-mounted lift-assist assemblies (e.g., a first lift-assist assembly 112 and a second lift-assist assembly 114) coupled to the toolbar assembly 110 such that the lift-assist assemblies 112, 114 are positioned at the forward-end 100A of the implement 100 and an articulating chassis assembly 116 coupled to the toolbar assembly 110 (e.g., via a connecting frame 118) such that the chassis assembly 116 is positioned at the aft end 100B of the implement 100. As such, the toolbar assembly 110 generally trails the forward-mounted lift-assist assemblies 112, 114 relative to the forward direction of the travel 106, while the chassis assembly 116 generally trails the toolbar assembly 110 relative to the forward direction of the travel 106.

In general, the toolbar assembly 110 may be configured to support a plurality of ground-engaging tools (not shown). Specifically, in several embodiments, the toolbar assembly 110 may be configured to support a plurality of row units for performing an agricultural operation within a field. For instance, each row unit may be coupled to the toolbar assembly 110 (e.g., via a four-bar linkage) in a manner that allows the row unit to be supported relative to the field via the toolbar assembly 110. As an example, in the illustrated embodiment, the implement 100 is configured as a strip-tillage implement. In such an embodiment, the toolbar assembly 110 may be configured to support a plurality of strip-tillage units or “row units”. As is generally understood, with a strip tillage implement, each row unit may include one or more ground-engaging tools for working the soil in narrow strips extending in the for-aft-direction FA of the implement 100. For instance, in one embodiment, each row unit may include one or more row cleaner disks, coulter disks, shanks or knives, finishing or conditioning units, and/or the like for tilling narrow strips of soil during the performance of a strip tillage operation. Additionally, each row unit may also incorporate one or more components for supplying agricultural materials to the soil, such as injectors or tubes for directing the agricultural material (e.g., fertilizer) stored within the storage tank(s) 104 into the worked soil. Alternatively, the toolbar assembly 110 may be configured to support any other suitable type of ground-engaging tools or row units (e.g., planter row units).

In several embodiments, the toolbar assembly 110 may be configured as a “winged” toolbar assembly. For instance, as shown in FIGS. 3-6, the toolbar assembly 110 includes a central toolbar section 120 and a pair of wing toolbar sections (e.g., a first or right wing toolbar section 122 and a second or left wing toolbar section 124). Specifically, the first wing toolbar section 122 may be coupled to a first lateral end 120A of the central toolbar section 120 while the second wing toolbar section 124 may be coupled to an opposed second lateral end 120B of the central toolbar section 120. With such a configuration, when the implement 100 is in the working position shown in FIGS. 1-6, the wing toolbar sections 122 124 may generally extend laterally outwardly from the central toolbar section 120 in a lateral direction of the implement 100 (indicated by arrow L in FIGS. 1-6).

As is generally understood, the various toolbar sections 120, 122, 124 may generally be configured to support a plurality of ground-engaging tools relative to the remainder of the implement 100. For instance, as indicated above, the toolbar assembly 110 may be configured to support a plurality of row units, in which case each toolbar section 120, 122, 124 may be coupled to and support one or more respective row units. In this regard, each toolbar section 120, 122, 124 may, for example, include mounting brackets 126 (FIGS. 4-6) spaced apart across its lateral width to allow a given number of row units to be mounted thereto.

In several embodiments, the toolbar assembly 110 may be configured to be coupled to the work vehicle 102 in a “semi-mounted” configuration. Specifically, as shown in FIG. 5, the central toolbar section 120 includes a pair of lower hitch brackets 128 for coupling the toolbar assembly 110 to the lower link (not shown) of the vehicle's hydraulic system (e.g., the lower link arms of a three-point hitch system), thereby allowing the implement 100 to be semi-mounted to the work vehicle 102. Additionally, as shown in FIG. 5, the central toolbar section 120 may also include an upper hitch bracket 130 for coupling the toolbar assembly 110 to the upper link (not shown) of the vehicle's hydraulic system (e.g., the upper link arm of a three-point hitch system), thereby allowing the implement 100 to be coupled to the work vehicle 102 in a “mounted” configuration. However, the implement 100 will generally be described herein with reference to the semi-mounted configuration in which only the lower links of the vehicle's hydraulic system are coupled to the toolbar assembly 110 (i.e., via the lower hitch brackets 128). With such a mounting configuration, only a portion of the weight of the implement 100 need be carried by the work vehicle 102, with the remainder of the weight being primarily supported via the forward-mounted lift-assist assemblies 112, 114 (as will be described in greater detail below).

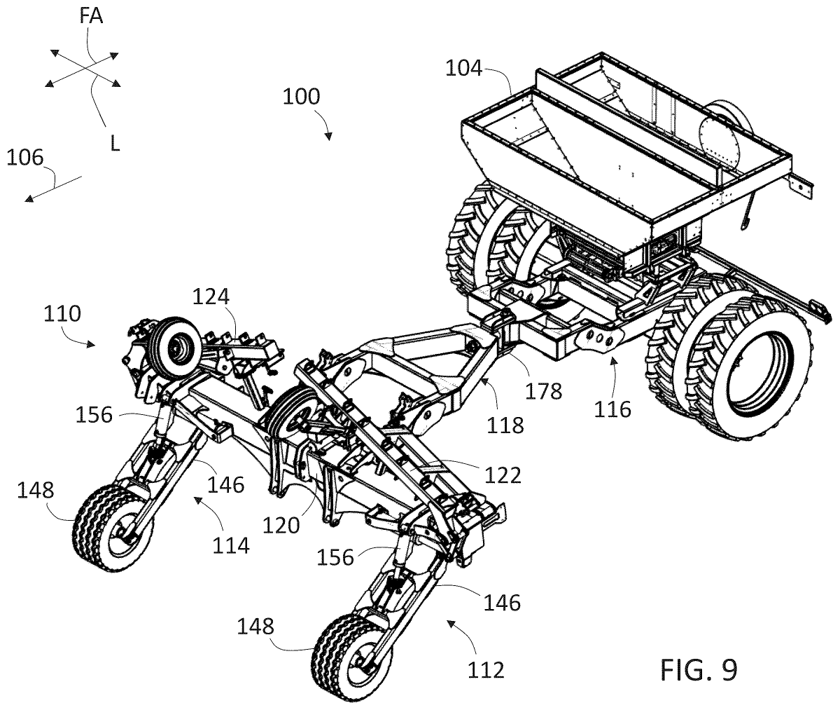

As particularly shown in FIGS. 4-6, each wing toolbar section 122, 124 may be pivotably coupled to the central toolbar section 120 via a respective pivot joint. Specifically, the first wing toolbar section 120 is coupled to the first lateral end 120A of the central toolbar section 120 via a first wing pivot joint 132, while the second wing toolbar section 124 is coupled to the second lateral end 120B of the central toolbar section 120 via a second wing pivot joint 132. Such pivot joints 132, 134 may generally allow the wing toolbar sections 122, 124 to be pivoted or folded relative to the central toolbar section 120 when transitioning the implement 100 from its working position to its transport position. For instance, as will be described below with reference to FIGS. 9-11, the wing toolbar sections 122, 124 may be configured to be pivoted or folded upwardly relative to the central toolbar section 120 to transition the implement 100 to its transport portion. In this regard, the implement 100 may include one or more wing actuators configured to effectuate such movement of the wing toolbar sections 122, 124 relative to the central toolbar section 120. For instance, as shown in FIGS. 4-6, a first wing actuator 136 (e.g., a hydraulic or pneumatic cylinder) may be coupled between the central toolbar section 120 and a first pivot linkage 138 provided at the first pivot joint 132 defined between the central toolbar section 120 and the first wing toolbar section 122, while a second wing actuator 140 (e.g., a hydraulic or pneumatic cylinder) may be coupled between the central toolbar section 120 and a second pivot linkage 142 provided at the second pivot joint 134 defined between the central toolbar section 120 and the second wing toolbar section 124. As such, retraction/extension of the wing actuators 136, 140 may result in the wing toolbar sections 122, 124 pivoting or folding relative to the central toolbar section 120 about their respective pivot joints 132, 134.

Moreover, as shown in FIGS. 1-4 and 5, a wing support wheel 144 may be coupled to each wing toolbar section 122, 124 (e.g., at the front of each wing toolbar section 122, 124) to support the toolbar section 122, 124 relative to the ground. In one embodiment, each wing support wheel 144 may be configured to function as a gauge wheel for its respective wing toolbar section 122, 124. In this regard, the vertical positioning of each wheel 144 relative to its associated wing toolbar section 122, 124 may be adjustable, as necessary, to allow the wing toolbar sections 122, 124 to be supported relative to the ground at the desired orientation/height.

Referring still to FIGS. 1-6, as indicated above, the implement 100 also includes a pair of lift-assist assemblies 112, 114 positioned at its forward end 100A for supporting a portion of the weight of the implement 100 and for assisting the vehicle's hydraulic system when moving the implement 100 from its working position to its transport position. As particularly shown in FIGS. 4 and 5 (and partially in FIG. 6), the lift-assist assemblies 112, 114 are generally positioned in the lateral direction L adjacent to the opposed lateral ends 120A, 120B of the central toolbar section 120 and extend outwardly therefrom in the forward direction of travel 106. Specifically, a first lift-assist assembly 112 is generally positioned adjacent to the first lateral end 120A of the central toolbar section 120 such that the lift assembly 112 is positioned inboard (i.e., closer to the longitudinal centerline of the implement 100 in the lateral direction L) of the first pivot joint 132 defined between the central toolbar section 120 and the first wing toolbar section 122. Similarly, a second lift-assist assembly 114 is generally positioned adjacent to the second lateral end 120B of the central toolbar section 120 such that the lift assembly 114 is positioned inboard (i.e., closer to the longitudinal centerline of the implement 100 in the lateral direction L) of the second pivot joint 134 defined between the central toolbar section 120 and the second wing toolbar section 124.

As particularly shown in FIGS. 5 and 6, each lift-assist assembly 112, 114 includes a wheel support frame 146 pivotably coupled to the central toolbar section 120 and a lift-assist wheel 148 supported by the support frame 146 for rotational relative thereto about the ground. In the illustrated embodiment, each wheel support frame 146 includes a pair of wheel support arms 150 (FIGS. 5 and 6) (e.g., parallel arms) and one or more cross-members 152 (FIGS. 5 and 6) extending between the wheel support arms 150 to form a ladder-like support structure. As shown in FIGS. 5 and 6, each wheel support arm 150 extends in the fore-aft direction FA between a proximal end 150A and a distal end 150B, with the proximal end 150A of each wheel support arm 150 being pivotably coupled to the center toolbar section 120 (e.g., at pivot joints 154) and the distal end 150B of each wheel support arm 150 being coupled to the associated lift-assist wheel 148 (e.g., via a wheel hub, bearing assembly, and/or the like) such that the wheel 158 is configured to rotate relative to the wheel support arm 146.

Additionally, as shown in FIGS. 5 and 6, each lift-assist assembly 112, 114 further includes one or more lift-assist actuators 156 (e.g., one or more hydraulic or pneumatic cylinders) pivotably coupled between the central toolbar section 120 and the wheel support frame 146 (e.g., one of the cross-members 152 of the wheel support frame 146). As will be described below, actuation of the lift-assist actuators 156 may result in an adjustment of the relative vertical positioning between the lift-assist wheels 148 and the toolbar assembly 110. Specifically, in the illustrated embodiment, retraction of the lift-assist cylinders 156 results in the lift-assist assemblies 112, 114 pivoting upward about their pivot joints 154 relative to the central toolbar section 120 such that a vertical height defined between the toolbar assembly 110 and a rotational axis 158 (FIGS. 2, 5, and 6) of each wheel 148 decreases as the toolbar assembly 110 is lowered relative to the ground. Such relative movement occurs when transitioning the implement 100 from its transport position to its working position. Similarly, in the illustrated embodiment, actuation of the lift-assist cylinders 156 results in the lift-assist assemblies 112, 114 pivoting downward about their pivot joints 154 relative to the central toolbar section 120 such that the vertical height defined between the toolbar assembly 110 and the rotational axis 158 of each wheel 148 increases as the toolbar assembly 110 is raised relative to the ground. Such relative movement occurs when transitioning the implement 100 from its working position to its transport position.

Due to the relative positioning and configuration of the lift-assist assemblies 112, 114, the lift-assist wheels 148 generally correspond to the forwardmost components of the implement 10 relative to the forward direction of travel 106. In this regard, given the semi-mounted configuration of the toolbar assembly 110 relative to the work vehicle 102, the lift-assist wheels 148 are generally configured to overlap with (or are otherwise aligned with) portions of the work vehicle 102 in the lateral direction L. For instance, the lift-assist wheels 148 are generally configured to laterally overlap or otherwise align with portions of the rear traction elements 108 of the work vehicle 102. Specifically, as shown in the top view of FIG. 2, the lift-assist wheels 148 are generally aligned with the rear traction elements 108 of the work vehicle when the implement 100 in the working position, with the rotational axes of the lift-assist wheels 148 (indicated by line 158 in FIG. 2) being positioned forward of the central axes of the rear traction elements 108 (indicated by line 160 in FIG. 2) by a given fore-aft spacing distance 162. However, as will be described below, while the implement 100 is transitioning from the working position to the transport position, the lift-assist wheels 148 move slightly rearwardly relative to the rear traction elements 108 of the work vehicle 102 as the lift-assist actuators 156 are actuated to pivot the lift-assist assemblies 112, 114 downward about their pivot joints 154 relative to the central toolbar section 120 in order to raise the toolbar assembly 110 relative to the ground. In one embodiment, such rearward movement of the lift-assist wheels 148 results in the rotational axes 158 of the lift-assist wheels 148 becoming aligned or substantially aligned with the central axes 160 of the rear traction elements 108 in the lateral direction L. For instance, in one embodiment, such rearward movement of the lift-assist wheels 148 results in the fore-aft spacing distance 162 being reduced to less than 8 inches when the implement 100 is in the transport position, such as less than 6 inches or less than 4 inches or less than 2 inches or less than 1 inch.

It should be appreciated that, when the rear traction elements 108 correspond to rear wheels of the work vehicle 102, the central axes 160 (FIG. 2) may generally correspond to the rotational axes of the wheels. Alternatively, when the rear traction elements 108 correspond to rear track assemblies of the work vehicle 102, the central axes 160 (FIG. 2) may generally correspond to the central rotational axis of the center wheel of the track assemblies.

Additionally, in several embodiments, the lateral positioning of the lift-assist assemblies 112, 114 may be selected such that the lift-assist wheels 148 are centered between the locations of adjacent row units configured to be coupled to the toolbar assembly 110. For instance, as shown in FIG. 2, each lift-assist wheel 148 is shown as being centered along a longitudinal wheel centerline (indicated by lines 164) that is equally spaced apart from longitudinal row unit centerlines (indicated by lines 116) of the respective row units configured to be coupled to the central toolbar section 120 along either side of the wheel centerline 164. Moreover, as shown in FIG. 2, the lateral positioning of the lift-assist assemblies 112, 114 may also be selected such that a sufficient lateral width 168 is defined between the lift-assist assemblies 112, 114 for accommodating the aft portion of the work vehicle 102 therebetween and for preventing contact between the lift-assist assemblies 112, 114 and the rear traction elements 108 of the work vehicle 102. In one embodiment, it may be desirable for a sufficient lateral gap to be defined between each lift-assist assembly 112, 114 and the adjacent rear traction element 108 of the work vehicle 102 to allow mud, residue, and/or the like to flow between such adjacent components without becoming stuck or plugged.

Referring still to FIGS. 1-6, as indicated above, the implement 100 further includes an articulating chassis assembly 116 coupled to the toolbar assembly 110 such that the chassis assembly 116 trails the toolbar assembly 110 relative to the forward direction of travel 106. As shown in FIGS. 1-3, the chassis assembly 116 may include a support frame 170 extending between a forward end 170A (FIG. 3) and an aft end 170B (FIG. 3), with the support frame 170 being configured to support one or more storage tanks 104 between its forward and aft ends 170A, 170B. For instance, the storage tank(s) 104 may correspond to a fertilizer tank or any other suitable type of storage tank configured to store an agricultural material. In addition, the chassis assembly 116 may include one or more chassis support wheels 172. For example, as particularly shown in FIGS. 1-3, two pairs of support wheels 172 may be coupled to the the support frame 170 to support the chassis assembly 116 relative to the ground.

As shown in FIGS. 1-3, the chassis assembly 116 is coupled to the toolbar assembly 110 via an intermediate or connecting frame 118. Specifically, the connecting frame 118 may be configured to extend in the fore-aft direction FA between a forward frame end 118A and an aft frame end 118B, with the forward frame end 118A being pivotably coupled to the central toolbar section 120 of the toolbar assembly 110 and the aft frame end 118B being coupled to the forward end 170A of the support frame 170 of the chassis assembly 116. In one embodiment, the connecting frame 118 is configured to be pivotably coupled to the central toolbar section 120 via a pair of pivot joints 174 (FIG. 3) defining horizontally oriented pivot axes that allow the connecting frame 118 to pivot upwards/downwards relative to the toolbar assembly 110. In this regard, the implement 100 may also include one or more connecting frame actuators 176 (e.g., one or more hydraulic or pneumatic cylinders) that, when actuated, result in the connecting frame 118 pivoting relative to the toolbar assembly 110 at the pivot joints 174. For instance, as shown in FIGS. 3-5, a pair of connecting frame actuators 176 are coupled between the central toolbar section 120 and the connecting frame 118 to control such pivotable movement of the connecting frame 118 relative to the toolbar assembly 110.

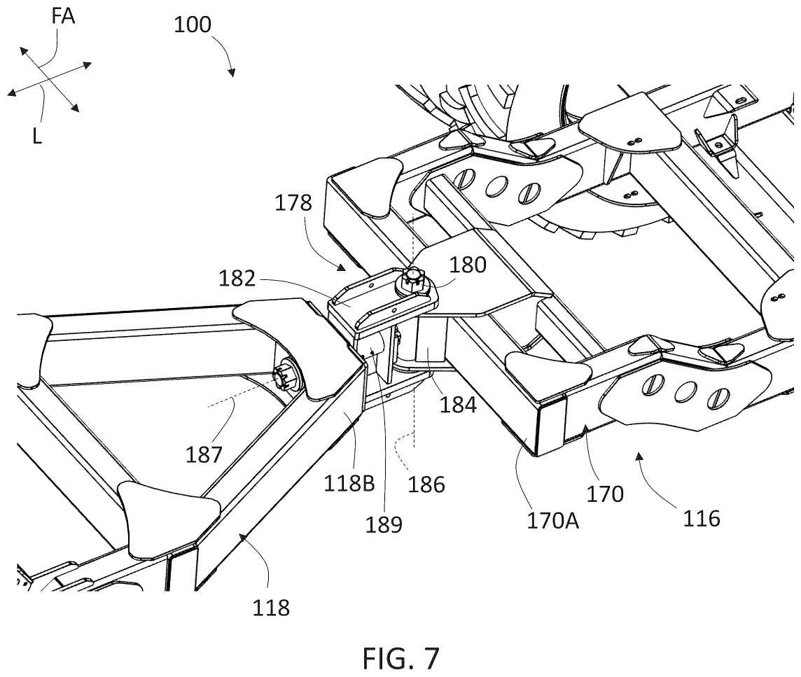

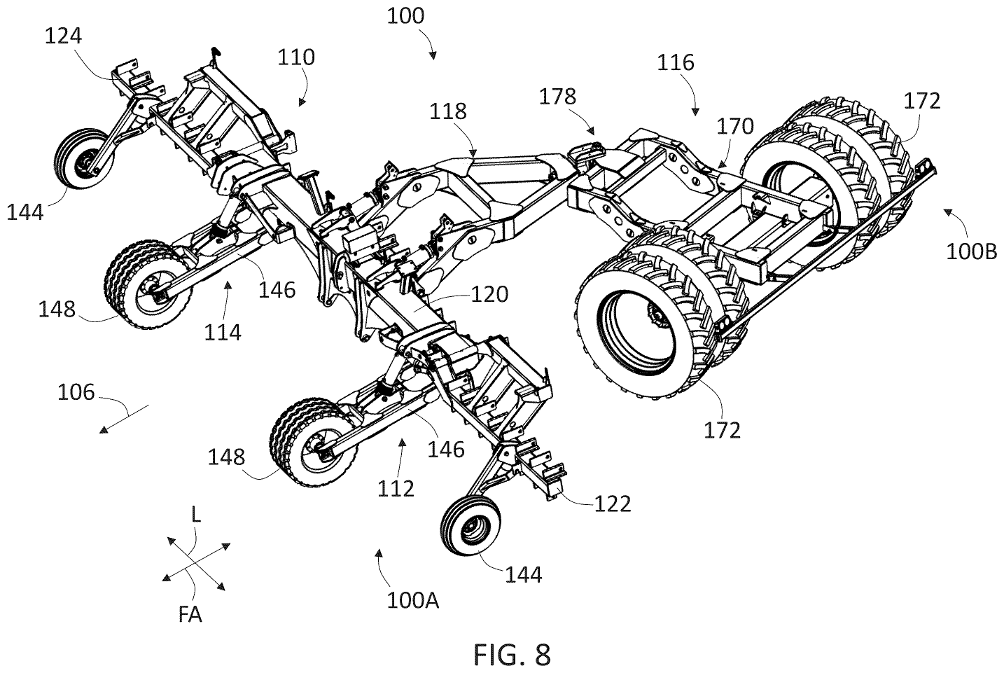

In several embodiments, the connection or coupling between the connecting frame 118 and the chassis assembly 116 may be configured as an articulation joint that allows the chassis assembly 116 to articulate or pivot about a vertical pivot axis relative to the connecting frame 118 (and the remainder of the implement 100). For example, FIG. 7 illustrates a perspective view of one embodiment of an articulation joint 178 that may be provided between the aft frame end 118B of the connecting frame 118 and the forward end 170A of the support frame 170 of the chassis assembly 116 to allow the chassis assembly 116 to articulate or pivot relative thereto. Specifically, as shown in FIG. 7, the articulation joint 178 is formed as a pinned connection between the connecting frame 118 and the chassis assembly 116 (e.g.., via a pin 180 extending vertically through both a clevis 182 mounted to the aft frame end 118B of the connecting frame 118 and a pivot bracket 184 extending from the forward end 170A of the support frame 170) such that the chassis assembly 116 is pivotable relative to the connecting frame 118 via a vertical articulation axis 186. Accordingly, the articulation joint 178 allows the chassis assembly 129 to turn or pivot independently of the remainder of the implement 100 when making turns. For instance, FIG. 8 illustrates a perspective view of the implement 100 shown in FIGS. 3-6 with the chassis assembly 116 turned or articulated relative to the reminder of the implement 100 about the articulation joint 178, which may occur during the performance of sharp turns (e.g., headland turns).

Referring back to FIG. 7, in one embodiment, the articulation joint 178 may also be configured to allow the chassis assembly 116 to pivot relative to the connecting frame 118 about a horizonal roll axis 187. For instance, as shown in the illustrated embodiment, the clevis 182 of the articulation joint 182 may be pivotably coupled to the aft frame end 118 of the connecting frame via a pin 189 extending in the fore-aft direction FA. Such a roll axis 187 may allow for the tractor/implement to be position on different slopes/contours.

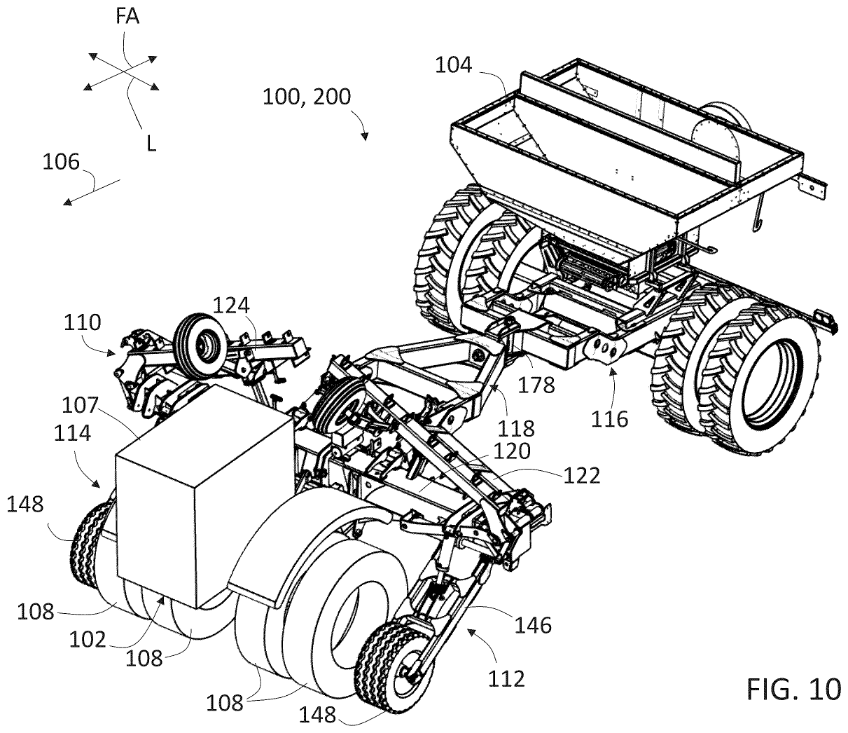

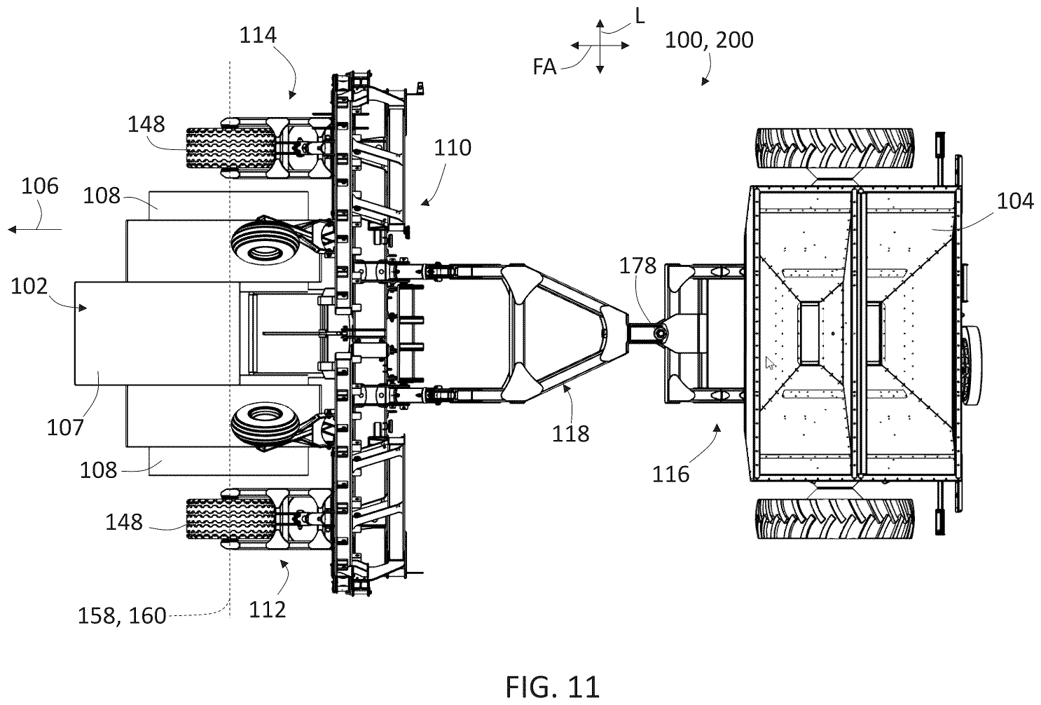

Referring now to FIGS. 9-11, various views of the implement 100 described above when in its transport position are illustrated in accordance with aspects of the present subject matter. Specifically, FIG. 9 illustrates a perspective view of the implement 100 in the transport position, while FIG. 10 illustrates the same perspective view of the implement 100 with the addition of the aft portion of the work vehicle 102 shown in FIGS. 1 and 2. Moreover, FIG. 11 illustrates a top view of the implement 100 and aft portion of the work vehicle 102 shown in FIG. 10.

As indicated above, when moving from the working position to the transport position, the transport assembly 110 is configured to be raised relative to the ground. Such lifting of the transport assembly 110 is effectuated using both the tow vehicle's hydraulic system (i.e., via the connection provided by the semi-mounted hitch configuration) and the lift-assist assemblies 112, 114. Specifically, in combination with any lifting force provided by the vehicle's hydraulic system, actuation of the lift-assist actuators 156 results in the toolbar assembly 110 being raised upwardly relative to the ground as the lift-assist assemblies 112, 114 pivot downwardly relative to the central toolbar section 120 about their associated pivot joints 154. As described above, such downward pivoting of the lift-assist assemblies 112, 114 results in rearward movement of the lift-assist wheels 148 relative to the work vehicle 102 such that the rotational axes 158 of the lift-assist wheels 148 become aligned or substantially aligned with the central axes 160 of the rear traction elements 108 of the work vehicle 102 in the lateral direction L.

For instance, as shown in the top view of FIG. 11, when the implement 100 is in the transport position, the rotational axes 158 of the lift-assist wheels 148 are aligned with the central axes 160 of the rear traction elements 108 along a common vertical plane (indicated by common line 158, 160) extending in the lateral direction L of the implement 100. Such alignment of the axes 158, 160 allows for smooth turning of the vehicle/implement without any skidding or sliding of the lift-assist wheels 112, 114. However, in other embodiments, a small fore-aft spacing distance 162 (FIG. 2) may be defined between the rotational axes 158 of the lift-assist wheels 148 and the central axes 160 of the rear traction elements 108 in the fore-aft direction FA without significant detrimental impacts to the turning performance of the vehicle/implement, such as a spacing distance of less than 8 inches, or less than 6 inches, or less than 4 inches, or less than 2 inches, or less than 1 inch.

As shown in FIGS. 9-11, the transport position for the implement 100 may also be characterized by the wing toolbar sections 122, 124 being folded over the top of the central toolbar section 120 and the connecting frame 118 being pivoted downwardly relative to the toolbar assembly 110. For example, as indicated above, when transitioning from the working position to the transport position, the wing actuators 136, 140 may be actuated to pivot or fold the wing toolbar sections 122, 124 upwardly relative to the central toolbar section 120 about their pivot joints 132, 134 into the positions shown in FIGS. 9-11. Additionally, the connecting frame actuator 176 may similarly be actuated to maintain the proper orientation between the toolbar assembly 110 and the connecting frame 118 as the toolbar assembly 110 is being raised upwardly relative to the ground.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. An agricultural implement extending in a fore-aft direction between a forward end and an aft end, the agricultural implement comprising:
a toolbar assembly comprising a central toolbar section and first and second wing toolbar sections pivotably coupled to the central toolbar section, the central toolbar section configured to be mounted to a work vehicle via a semi-mounted configuration; and
first and second lift-assist assemblies pivotably coupled to the central toolbar section and extending outwardly therefrom in a forward direction of travel of the implement such that the lift-assist assemblies are positioned at forward end of the agricultural implement.

2. The agricultural implement of claim 1, further comprising an articulating chassis assembly coupled to the toolbar assembly and being disposed in a trailing position relative to the toolbar assembly relative to the forward direction of travel such that the chassis assembly is positioned at the aft end of the agricultural implement.

3. The agricultural implement of claim 2, wherein the chassis assembly is pivotably coupled to the toolbar assembly via a connecting frame, the connecting frame extending in the fore-aft direction between a forward frame end and an aft frame end, the forward frame end being pivotably coupled to the central toolbar section of the toolbar assembly, the aft frame end being coupled to the chassis assembly via an articulation joint.

4. The agricultural implement of claim 2, wherein the chassis assembly comprises a support frame configured to support one or more storage tanks for storing an agricultural material.

5. The agricultural implement of claim 1, wherein each of the first and second lift-assist assemblies includes a support frame pivotably coupled to the central toolbar section and a lift-assist wheel coupled to the support frame for rotation relative thereto.

6. The agricultural implement of claim 5, wherein the first and second lift-assist assemblies are positioned forward of the toolbar assembly relative to the forward direction of travel of the implement such that the lift-assist wheel of each of the first and second lift-assist assemblies is configured to be aligned with a rear traction element of the work vehicle in a lateral direction of the implement when the implement is coupled to the work vehicle in the semi-mounted configuration.

7. The agricultural implement of claim 5, further comprising a first wing support wheel coupled to the first wing toolbar section and a second wing support wheel coupled to the second wing toolbar section, the first and second wing support wheels being separate from the lift-assist wheels of the first and second lift-assist assemblies.

8. An agricultural system, comprising:
a work vehicle including first and second rear traction elements; and
an agricultural implement configured to be towed by the work vehicle, the agricultural implement comprising:
a toolbar assembly including a central toolbar section and first and second wing toolbar sections pivotably coupled to the central toolbar section, the central toolbar section configured to be mounted to the work vehicle via a semi-mounted configuration; and
first and second lift-assist assemblies pivotably coupled to the central toolbar section and extending outwardly therefrom in a forward direction of travel of the agricultural implement such that the lift-assist assemblies are at least partially aligned with the first and second rear traction elements of the work vehicle in a lateral direction of the agricultural implement.

9. The agricultural system of claim 8, wherein the first and second rear traction elements comprise one of first and second rear wheels of the work vehicle or first and second rear track assemblies of the work vehicle.

10. The agricultural system of claim 8, further comprising an articulating chassis assembly coupled to the toolbar assembly and being disposed in a trailing position relative to the toolbar assembly.

11. The agricultural system of claim 10, wherein the chassis assembly is pivotably coupled to the toolbar assembly via a connecting frame, the connecting frame extending in a fore-aft direction of the implement between a forward frame end and an aft frame end, the forward frame end being pivotably coupled to the central toolbar section of the toolbar assembly, the aft frame end being coupled to the chassis assembly via an articulation joint.

12. The agricultural system of claim 10, wherein the chassis assembly comprises a support frame configured to support one or more storage tanks for storing an agricultural material.

13. The agricultural system of claim 8, wherein each of the first and second lift-assist assemblies includes a support frame pivotably coupled to the central toolbar section and a lift-assist wheel coupled to the support frame for rotation relative thereto.

14. The agricultural system of claim 13, wherein the first and second lift-assist assemblies are positioned forward of the toolbar assembly relative to the forward direction of travel of the implement such that the lift-assist wheel of each of the first and second lift-assist assemblies is aligned with first and second rear traction elements of the work vehicle in the lateral direction of the implement.

15. The agricultural system of claim 14, wherein a rotational axis of each lift-assist wheel is aligned with a central axis of the first and second rear traction elements about a common vertical plane extending in the lateral direction when the implement is moved to a transport position.

16. The agricultural system of claim 14, wherein a rotational axis of each lift-assist wheel is offset from a central axis of the first and second rear traction elements in the fore-aft direction by a spacing distance that is less than 8 inches.

17. The agricultural system of claim 13, further comprising a first wing support wheel coupled to the first wing toolbar section and a second wing support wheel coupled to the second wing toolbar section, the first and second wing support wheels being separate from the lift-assist wheels of the first and second lift-assist assemblies.

18. An agricultural implement extending in a fore-aft direction between a forward end and an aft end, the agricultural implement comprising:
a toolbar assembly comprising a central toolbar section and first and second wing toolbar sections pivotably coupled to the central toolbar section;
first and second lift-assist assemblies pivotably coupled to the central toolbar section and extending outwardly therefrom in a forward direction of travel of the implement such that the lift-assist assemblies are positioned at forward end of the agricultural implement; and
an articulating chassis assembly coupled to the toolbar assembly and being disposed in a trailing position relative to the toolbar assembly such that the chassis assembly is positioned at the aft end of the agricultural implement.

19. The agricultural implement of claim 18, wherein the chassis assembly is pivotably coupled to the toolbar assembly via a connecting frame, the connecting frame extending in the fore-aft direction between a forward frame end and an aft frame end, the forward frame end being pivotably coupled to the central toolbar section of the toolbar assembly, the aft frame end being coupled to the chassis assembly via an articulation joint.

20. The agricultural implement of claim 18, wherein the chassis assembly comprises a support frame configured to support one or more storage tanks for storing an agricultural material.

21. The agricultural implement of claim 18, wherein each of the first and second lift-assist assemblies includes a support frame pivotably coupled to the central toolbar section and a lift-assist wheel coupled to the support frame for rotation relative thereto.

22. The agricultural implement of claim 21, wherein the first and second lift-assist assemblies are positioned forward of the toolbar assembly relative to the forward direction of travel of the implement such that the lift-assist wheel of each of the first and second lift-assist assemblies is configured to be aligned with a rear traction element of the work vehicle in a lateral direction of the implement when the implement is coupled to the work vehicle in a semi-mounted configuration.

23. The agricultural implement of claim 21, further comprising a first wing support wheel coupled to the first wing toolbar section and a second wing support wheel coupled to the second wing toolbar section, the first and second wing support wheels being separate from the lift-assist wheels of the first and second lift-assist assemblies.
